(19) United States
(12) Patent Application Publication
(10) Pub. No.: US 2016/0214296 A1
(43) Pub. Date: Jul. 28, 2016

(54) HOT RUNNER SYSTEM INCLUDING THERMAL EXPANSION COMPENSATION DEVICE

(71) Applicant: Hyuk-Joong KIM, Seoul (KR)

(72) Inventor: Hyuk-Joong KIM, Seoul (KR)

(21) Appl. No.: 14/917,361

(22) PCT Filed: Sep. 4, 2014
(86) PCT No.: PCT/KR2014/008306

§ 371 Date: Mar. 8, 2016

(30) Foreign Application Priority Data
Sep. 9, 2013 (KR) 10-2013-0108166

(51) Int. Cl. B29C 45/27

(52) U.S. Cl. CPC B29C 45/2725; B29C 2045/2729; B29C 2045/2733; B29C 2045/2791

(57) ABSTRACT

Disclosed is a hot runner system including a thermal expansion compensation device. The hot runner system including a thermal expansion compensation device, according to the present invention, compensates for the dislocation of a joint between a manifold and a resin due to thermal expansion of the manifold heated by a heating wire at a high temperature so as to prevent the leakage of the resin resulting from a gap formed therebetween and to appropriately maintain the flowability of the resin. Thus, high reliability can be secured according to the arrangement of the simplified structure between the manifold and nozzles.

### TECHNICAL FIELD

The present invention relates to a hot runner system including a manifold and a nozzle which are employed to inject a melted resin into a cavity of a mold, and in particular to a hot runner system including a thermal expansion compensation device, according to the present invention, compensates for the dislocation of a joint between a manifold and a resin due to thermal expansion of the manifold heated by a heating wire at a high temperature so as to prevent the leakage of the resin resulting from a gap formed therebetween and to appropriately maintain the flowability of the resin. Thus, a mechanical alignment between the manifold and the nozzle can be obtained stable.

### BACKGROUND ART

The hot runner system for forming a plastic product is an system wherein a resin material is injected from a resin-melted shape cylinder into a manifold, and the injected resin is evenly distributed along a resin flow path branched and formed in the manifold and is supplied to one or more nozzles coupled to a lower end portion of the manifold, and is finally injected into a forming space, namely, a cavity, formed by upper and lower cores which belong to a forming frame used to form the product.

More specifically, the hot runner system is an system which is able to inject a melted state resin into a mold in a liquid phase state. The mold is divided into upper and lower cores which are disposed symmetrical. A manifold is connected to the upper core so as to evenly inject the resin into a cavity which is a forming space formed at the lower core. A plurality of nozzles which are injection components for injecting the resin into the cavity of the lower mold are formed at the lower surface of the manifold, by means of which the resin can be filled into the cavity in a high pressure state. When the thusly filled resin is hardened, the upper and lower molds are separated, and the formed product is taken out.

The manifold is equipped with a branched resin flow path inside the manifold, through which a melted state resin flows. Electric heated wires, which are heating elements heated upon the supply of electric power, are installed around the resin flow path so as to prevent the resin from hardening. In this structure, there are provided a nozzle engaging hole connected to the resin flow path so as to guide the flow of the resin toward the nozzles, and a resin inflow hole which is connected to the cylinder, which is an injection molding machine, so as to supply the melted resin to the branched resin flow path.

Moreover, the nozzle is configured in such a way that the top of the nozzle is connected to the nozzle engaging hole of the manifold, thus receiving the resin. This nozzle may be categorized into a pin type which is able to open and close the opening of the nozzle in cooperation with the ascending and descending operations of a piston disposed in an air cylinder which is configured to receive a high pressure air, and a pin-less type which is designed to use the hardening and melting phenomena of the resin thanks to a temperature difference at an end portion of the nozzle contacting with the mold.

The conventional hot runner system might have a position displacement due to a thermal expansion phenomenon since the manifold made of a metal is heated hot by heating wires which are a heater. Since this position displacement applies to the connected portions of the nozzle, an offset phenomenon may consequently occur, wherein the center of the nozzle is distorted.

If the relational position between the manifold and the nozzle is distorted, a gap may be consequently formed at the connected portions between the manifold and the nozzle, whereupon the resin may leak through the thusly formed gap, and a smooth supply and flow of the melted resin may interrupted for the above reason.

As a conventional technology developed in an effort to resolve the aforementioned problems, the “injection molding machine” of the Korean patent registration No. 10-0669173 describes a solution wherein any damages to the system can be prevented in such a way that a predetermined force, for example, a buffering power, etc. is generated inside the system so as to withstand the thermal expansion with the aid of a bush which is designed to cooperate with the thermal expansion.

The aforementioned technology which has been developed to prevent any position distortion of the nozzle due to the thermal expansion of the manifold may need a complicated configuration, and the processing procedure is difficult to carry out, and the manufacturing cost is high, and the maintenance is not easy.

### DISCLOSURE OF INVENTION

Accordingly, the present invention is made in an effort to resolve the above-mentioned problems. It is an object of the present invention to provide a hot runner system including a thermal expansion compensation device which makes it possible to provide a reliability to a product with the aid of an enhanced position stability of the nozzle in such a way to compensate a position deviation which may occur at the connection portions of the nozzle due to the thermal expansion of the manifold.

It is another object of the present invention to provide a hot runner system including a thermal expansion compensation device which is able to provide an economical manufacturing and an enhanced convenience in terms of maintenance with the aid of simplified configurations.

To achieve the above objects, there is provided a hot runner system including a thermal expansion compensation device, which may include, but is not limited to, a manifold which includes a resin flow path formed inside of the manifold, wherein a resin flows through the resin flow path, and a nozzle engaging hole which is connected to the resin flow path and has an enlarged diameter; a tubular nozzle an upper end portion of which is connected to a nozzle engaging hole of the manifold, and a lower end of which is connected to a cavity of a mold, thus injecting the resin, wherein a resin path connected to the resin flow path is formed inside of the tubular nozzle; and a thermal expansion compensation device which is provided to compensate any position distortion of the nozzle due to the thermal expansion of the manifold, wherein the thermal expansion compensation device is a tubular connection component made of a metal having a relatively larger thermal expansion rate than those of the manifold and the nozzle, with a resin connection path having the same diameter as those of the resin flow path and the resin path being passing through the tubular connection component, wherein the thermal expansion compensation device includes a thermally transformable gasket bushing formed of a fixed flange part which is shrink-fitted into the inner surface of the engaging hole of the nozzle, a transformation pipe part which is extending downward from the fixed flange part and is configured to form a transformation compensation gap since it has a diameter smaller than that of the nozzle engaging hole, and a nozzle assembling part which is extending downward from the transformation pipe part and is formed inside of the top of the nozzle and is connected to the resin path and is assembled shrink-filled to an installation groove having a larger diameter than that of the resin path.

As a preferred feature of the present invention, the transformation pipe part of the thermally transformable gasket bushing is formed in a cylindrical pipe shape having a thickness smaller than the fixed flange part or is formed, with a spiral pattern, a protrusion pattern or a wrinkle pattern being formed on the outer surface thereof so as to induce any transformation due to the thermal expansion of the manifold.

As another preferred feature of the present invention, the thermal expansion compensation device may include, but is not limited to, a cover bushing which is a tubular component covering a part of the outer surface of the thermally transformable gasket bushing and is made of a metallic material having a smaller thermal expansion rate than that of the thermally transformable gasket bushing.

As further another embodiment of the present invention, the cover bushing may include, but is not limited to, a bushing body part an upper end portion of which is contacting with a lower portion of the fixed flange part of the thermally transformable gasket bushing, thus forming a transformation compensation gap on the outer surface of the transformation pipe part; and an insertion part which is extending downward from the bushing body part, wherein a lower end of the insertion part is assembled inserted into the outer surface of the top of the nozzle.

### Advantageous Effects

As advantages of the present invention, the hot runner system including a thermal expansion compensation device according to the present invention is able to previously prevent any damages which might occur due to the leakage of a resin, in such a way to prevent the formation of any gap at the connected portions between the manifold and the nozzle since the position of the nozzle which might be distorted due to the thermal expansion of the manifold can be compensated.

The economical manufacturing and supply of the product are available thanks to simplified configurations, and since a reliable convenience in terms of maintenance can be provided, the reliability of the product can be enhanced, whereupon the present invention has an effect on an actual industrial application.

The features and advantages of the present invention will become clear through the following detailed descriptions along with the drawings. The terms or words used throughout the specification and claims should not be interpreted based on the typical and dictionary definitions, but should be interpreted as the meaning and concepts which well match with the technical idea of the present invention based on the principle that the inventor can define them in proper ways to describe his invention in the best way.

### BRIEF DESCRIPTION OF DRAWINGS

FIG. 1 is a cross sectional view for describing a hot runner system including a thermal expansion compensation device according to an embodiment of the present invention.

FIG. 2 is a major component-enlarged view for describing the operation of a compensation device due to a thermal expansion of a manifold in FIG. 1.

FIG. 3 is a cross sectional for describing a hot runner system including a thermal expansion compensation device according to another embodiment of the present invention.

FIG. 4 is a major component-enlarged view for describing the operation of a compensation device due to a thermal expansion of a manifold in FIG. 1.

### LEGEND OF REFERENCE NUMBERS

10: Manifold 11: Resin flow path

20: Nozzle 21: Resin path

30: Thermal expansion compensation device

31: Resin connection path

### BEST MODES FOR CARRYING OUT THE INVENTION

The hot runner system including a thermal expansion compensation device according to the present invention will be described with reference to the accompanying drawings. It is noted that the same components or parts are given the same reference numbers. The descriptions on the known function or configuration in the course of the descriptions of the present invention will be omitted to avoid making unclear the subjects of the present invention.

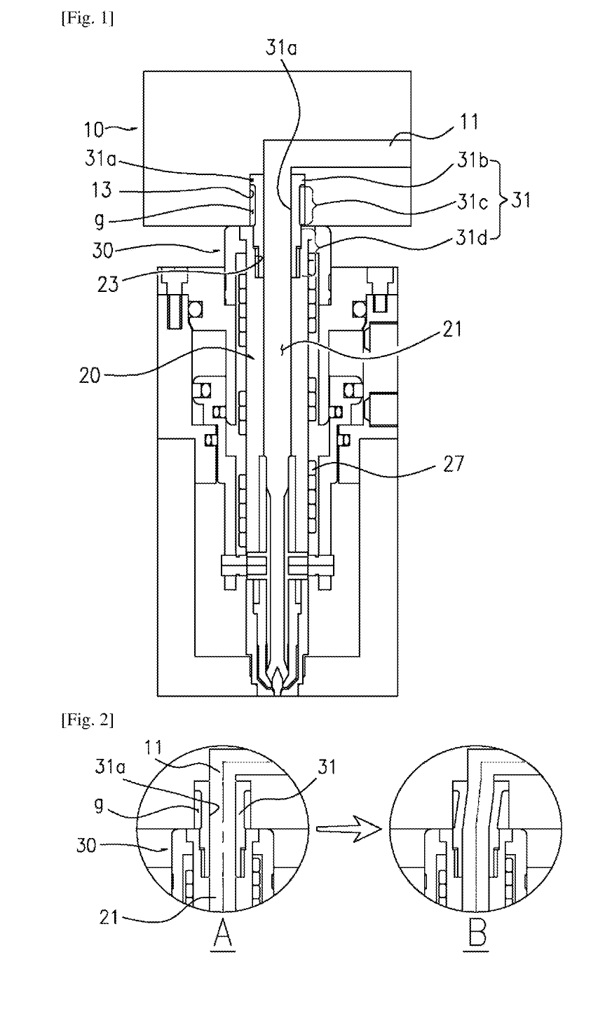

FIG. 1 is a cross sectional view for describing a hot runner system including a thermal expansion compensation device according to an embodiment of the present invention. FIG. 2 is a major component-enlarged view for describing the operation of a compensation device due to a thermal expansion of a manifold in FIG. 1.

As illustrated in the drawings, the hot runner system including a thermal expansion compensation device according to the present invention may include, but is not limited to, a manifold 10 which is provided to receive a resin from an injection machine (a reference number is not assigned) and branch and guide the resin through a resin flow path 11 formed inside the manifold 10 toward a nozzle 20, the nozzle 20 which is coupled to a lower portion of the manifold 10 and is provided to inject the resin into the cavity of the mold formed of upper and lower cores, and a thermal expansion compensation device 30 which is a component for interconnecting the manifold 10 and the nozzle 20 and is a compensating component for compensating any position displacement due to the thermal expansion of the manifold 10, thus maintaining the phase of the status of the nozzle 20.

The configuration of a hot runner valve device including a thermal expansion compensation device according to an embodiment of the present invention will be described.

The hot runner system including a thermal expansion compensation device according to the present invention may include, but is not limited to, a manifold 10 which is provided to receive a resin from an injection machine and includes a plurality of nozzles provided at the lower surface thereof, a nozzle 20 which is coupled to the lower surface of the manifold 10 and is provided to receive a resin and inject it into the inside of a cavity of a mold, and a thermal expansion compensation device 30 which is able to compensate any displacement at the connected portions between the manifold 10 and the nozzle 20 due to the thermal expansion of the manifold 10.

First, the injection machine used throughout the description of the present invention is a device for melting a resin and injecting the melted resin at a predetermined pressure. This device is operated by a known technology, so the detailed descriptions thereof will be omitted.

A branched resin flow path 11 through which the melted resin flows is formed inside the manifold 10. Electric wires (not illustrated) are buried around the resin flow path 11, wherein the electric wires can be heated upon the supply of electric power to prevent the flowing resin from hardening.

Moreover, a nozzle engaging hole 13 is formed at the lower surface of the manifold 10 and is connected to the resin flow path 11, wherein the nozzle 20 is installed at the nozzle engaging hole 13. The nozzle engaging hole 13 has a diameter enlarged larger with respect to the resin flow path 11.

Since the manifold 10 can be configured by the known technology, the description thereon will be omitted.

The top of the nozzle 20 is connected to the nozzle engaging hole 13 of the manifold 10 and is configured to receive a resin, and a lower end portion of the nozzle 20 is connected to the cavity of the mold, by means of which the resin supplied from the manifold 10 can be guided toward the cavity.

The nozzle 20 is formed in a tubular shape wherein the resin path 21 passes through in the vertical direction in order for the resin to flow, and the lower portions of the nozzle 20 have the diameters gradually decreasing toward the lower portions thereof. Heater wires 27 are disposed at the outer surfaces of the nozzle 20, wherein the heater wires 27 are configured to be heated upon the supply of an external electric power in order to prevent the hardening of the resin which flows along the resin path 21 formed inside the nozzle 20.

This configuration might be modified by the known technology during the designing based on the type and size of the molded product of the nozzle 20, so the detailed description thereof will be omitted.

As illustrated in FIGS. 1 and 2, the thermal expansion compensation device 30 is equipped with major technical features of the present invention. It is preferably made of a predetermined material which has a relatively higher thermal expansion coefficient than that of the manifold 10 and the nozzle 20. More specifically, it is made of a material having a high thermal expansion rate.

The thermal expansion compensation device 30 according to the present invention may include a tubular and thermally transformable gasket bushing 31 through which a resin connection path 31a having the same diameter as the resin flow path 11 of the manifold 10 and the resin path 21 of the nozzle 20 is passing, and a cover bushing 35 which is provided covering the outer surface of the thermally transformable gasket busing 31 and is made of a metal having a lower thermal expansion coefficient than that the thermally transformable gasket bushing 31, namely, a metal having a low thermal expansion rate.

The thermally transformable gasket bushing 31 may include a fixed flange part 31b which is assembled shrink-fitted to the inner surface of the nozzle engaging hole 13 of the manifold 10, a transformation pipe part 31 c which is extending downward from the fixed flange part 31b and is able to form a transformation compensation gap (g) with the aid of a diameter smaller than the nozzle engaging hole 13, and a nozzle assembling part 31d which is extending downward therefrom and is formed in the inside of the top of the nozzle 20 and is connected to the resin path 21 and is assembled shrink-fitted to an installation groove 23 having a diameter enlarged larger than the resin path 21.

The fixed flange part 31b is a component which is inserted shrink-fitted into an upper end portion of the inside of the nozzle engaging hole 13 as illustrated in the drawings and is equipped with a thickness relatively thicker than the transformation pipe part 31c. This configuration is provided in an effort to prevent any transformation from occurring at the fixed flange part 31b which has a relatively thicker thickness even when the manifold 10 is transformed due to the thermal expansion, whereby the closely inserted state into the nozzle engaging hole 13 can be maintained.

The transformation pipe part 31c has a relatively thinner thickness than the fixed flange part 31b since it needs to induce any smooth transformation thanks to the thermal expansion. The transformation pipe part 31c may include a transformation compensation gap (g) which is formed at the outer surface thereof so as to compensate any displacement due to the thermal expansion of the manifold 10, wherein the transformation compensation gap (g) may be employed by properly considering the thermal expansion rate of the manifold 10, and it is preferred that the gap has a size range of 0.1˜3 mm.

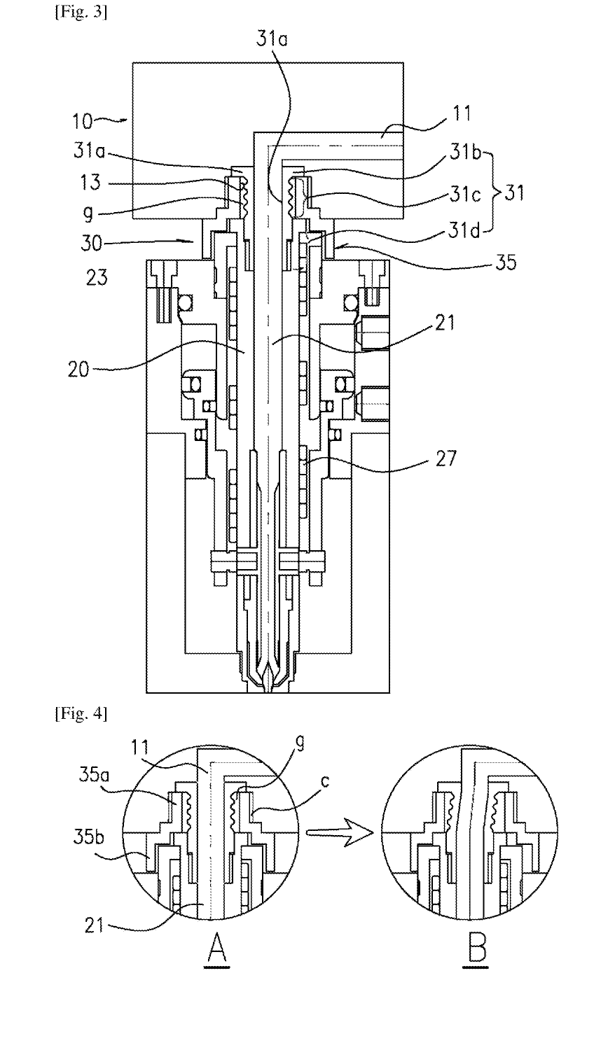

Meanwhile, as illustrated in FIG. 3, it is preferred that a spiral pattern, a protrusion pattern or a wrinkle pattern is formed on the outer surface of the transformation pipe part 31c so as to prevent any breaking during the transformation due to the thermal expansion of the manifold 10.

As illustrated in the drawings, the nozzle assembling part 31d is engaged inserted in the installation groove 23 formed at an upper end portion of the nozzle 20. The installation groove 23 is connected to the resin path 21 and is equipped with an enlarged diameter larger than that of the resin path 21, and the nozzle assembling part 31d is assembled shrink-fitted to the installation groove 23.

Meanwhile, it is preferred that the nozzle assembling part 31d is assembled to the installation groove 23 in a stepped insertion structure.

The operation of the hot runner system including a thermal expansion compensation device according to an embodiment of the present invention will be described with reference to FIG. 2. As seen at (A) of the left side thereof, an arranged state is maintained, wherein the resin flow path 11 of the manifold 10, the resin path 21 of the nozzle 20 and the resin connection path 31a of the thermally transformable gasket bushing 31 are disposed straight.

In this state, if a thermal expansion occurs since the manifold 10 is continuously heated by the electric wires, as seen at (B) of the right side in FIG. 2, the resin flow path 11 of the manifold 10 is transformed toward one side when viewing from the nozzle 20.

Since the thermally transformable gasket bushing 31 which belongs to the thermal expansion compensation device 30 of the present invention, transforms, as illustrated in the drawings, as much as the thermal expansion transformation of the manifold 10, whereby the position of the nozzle 20 can be maintained, and any displacement due to the thermal expansion of the manifold 10 can be compensated.

Since the thermally transformable gasket bush 31 is able to maintain the stable connected state between the resin flow path 11 of the manifold 10 and the resin path 21 of the nozzle 20, the formation of any gap can be interrupted, thus preventing any leakage of the resin.

FIG. 3 is a cross sectional for describing a hot runner system including a thermal expansion compensation device according to another embodiment of the present invention, and FIG. 4 is a major component-enlarged view for describing the operation of a compensation device due to a thermal expansion of a manifold in FIG. 3. The hot runner system including a thermal expansion compensation device according to an embodiment of the present invention has the same configuration as the previously described embodiment, provided that the hot runner system including a thermal expansion compensation device of this embodiment may include a cover bushing 35 which is provided at the outer surface of the thermally transformable gasket bushing 31 which belongs to the thermal expansion compensation device 30.

More specifically, this embodiment provides a technical feature wherein a part of the outer surface of the thermally transformable gasket bushing 31 is covered by the cover bushing 35 which has a thermal expansion coefficient lower than that of the thermally transformable gasket bushing 31, namely, has a lower thermal expansion rate, which configuration is provided to inhibit any breaking due to the quick transformation while enhancing the mechanical stability of the thermally transformable gasket bushing 31.

The thermally transformable gasket bushing 31 and the cover bushing 35 of this embodiment will be described below.

First, the thermally transformable gasket bushing 31 may include, but it not limited to, a fixed flange part 31b which is assembled shrink-fitted to the inner surface of the nozzle engaging hole 13 of the manifold 10, a transformation pipe part 31c which is extending downward from the fixed flange part 31b and is provided to form a transformation compensation gap (g) which is formed thanks to the diameter which is smaller than that of the nozzle engaging hole 13, and a nozzle assembling part 31d which is extending downward from the transformation pipe part 31c and is formed in the inside of the top of the nozzle 20 and is connected to the resin path 21 and is assembled shrink-fitted to the installation groove 23 which has an enlarged diameter larger than that of the resin path 21.

Since the thermally transformable gasket bushing 31 of this configuration has the same configuration as the previously described embodiment, the detailed description thereof will be omitted.

The cover bushing 35 having a major feature configuration of this embodiment is a tubular component which is able to cover a part of the outer surface of the thermally transformable gasket bushing 31 and is made of a metallic material having a thermal expansion coefficient smaller than that of the thermally transformable gasket bushing 31, namely, having a smaller thermal expansion rate.

As illustrated in FIGS. 3 and 4, the cover bushing 35 may include a bushing body part 35a an upper end portion of which is contacting with a lower portion of the fixed flange part 31b of the thermally transformable gasket bushing 31 and which is configured to form a transformation compensation gap (g) at the outer surface of the transformation pipe part 31c, and an insertion part 35b which is extending downward from the bushing body part 35a, wherein the lower portion of the insertion part 35b is assembled inserted in the outer surface of the top of the nozzle.

Meanwhile, it is preferred that the bushing body part 35a has a diameter smaller than that of the nozzle engaging hole 13 in order for the bushing body part 35a to be assembled to an outer side thereof, with a gap (c) being formed to the inner surface of the nozzle engaging hole 13. This configuration is provided so as to allow the bushing body part 35a to transform in the horizontal direction when any thermal expansion occurs at the manifold 10.

It is preferred that the cover bushing 35 is disposed contacting with the manifold 10 and the nozzle 20 and is made of a metallic material having a good thermal conduction quality, and it is preferred that it is made of a metal having a lower thermal expansion rate than that of the thermally transformable gasket bushing 31. For example, if the thermally transformable gasket bushing 31 is made of a copper, the cover bushing 35 is made of an alloy material containing a copper component. In this configuration, the cover bushing 35 is able to support from the outside thereof so as to prevent any quick transformation and breaking of the thermally transformable gasket bushing 31, while enhancing the structure strength at the connected portions between the manifold 10 and the nozzle 20.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A hot runner system including a thermal expansion compensation device, comprising:
a manifold which includes a resin flow path formed inside of the manifold, wherein a resin flows through the resin flow path, and a nozzle engaging hole which is connected to the resin flow path and has an enlarged diameter;
a tubular nozzle an upper end portion of which is connected to the nozzle engaging hole of the manifold, and a lower end of which is connected to a cavity of a mold, thus injecting the resin, wherein a resin path connected to the resin flow path is formed inside of the tubular nozzle; and
a thermal expansion compensation device which is provided to compensate position distortion of the nozzle due to the thermal expansion of the manifold,
wherein the thermal expansion compensation device is a tubular connection component made of a metal having a relatively larger thermal expansion rate than those of the manifold and the nozzle, with a resin connection path having the same diameter as those of the resin flow path and the resin path being passing through the tubular connection component, wherein the thermal expansion compensation device includes a thermally transformable gasket bushing formed of a fixed flange part which is shrink-fitted into the inner surface of the engaging hole of the nozzle, a transformation pipe part which is extending downward from the fixed flange part and is configured to form a transformation compensation gap since it has a diameter smaller than that of the nozzle engaging hole, and a nozzle assembling part which is extending downward from the transformation pipe part and is formed inside of the top of the nozzle and is connected to the resin path and is assembled shrink-filled to an installation groove having a larger diameter than that of the resin path.

2. The system of claim 1, wherein the transformation pipe part of the thermally transformable gasket bushing is formed in a cylindrical pipe shape having a thickness smaller than the fixed flange part or is formed, with a spiral pattern, a protrusion pattern or a wrinkle pattern being formed on the outer surface thereof so as to induce any transformation due to the thermal expansion of the manifold.

3. The system of claim 1, wherein the thermal expansion compensation device comprises:
a cover bushing which is a tubular component covering a part of the outer surface of the thermally transformable gasket bushing and is made of a metallic material having a smaller thermal expansion rate than that of the thermally transformable gasket bushing.

4. The system of claim 3, wherein the cover bushing comprises:
a bushing body part an upper end portion of which is contacting with a lower portion of the fixed flange part of the thermally transformable gasket bushing, thus forming a transformation compensation gap on the outer surface of the transformation pipe part; and
an insertion part which is extending downward from the bushing body part, wherein a lower end of the insertion part is assembled inserted into the outer surface of the top of the nozzle.
